(19) United States
(12) Patent Application Publication
(10) Pub. No.: US 2024/0236577 A9
(43) Pub. Date: Jul. 11, 2024

(54) ELECTRODYNAMIC LOUDSPEAKER FOR HORN WITH IMPROVED THERMAL DISSIPATION AND MANUFACTURING METHOD

(71) Applicant: ESTUDIO DE ASESORAMIENTO JOFARMA, S.L, VALENCIA (ES)

(72) Inventors: Jose MARTINEZ IRANZO, MONCADA, VALENCIA (ES); Jorge SERRANO RAMIREZ, MONCADA, VALENCIA (ES)

(21) Appl. No.: 18/547,314

(22) PCT Filed: Feb. 18, 2022
(86) PCT No.: PCT/ES2022/070083

§ 371 Date: Aug. 21, 2023

(30) Foreign Application Priority Data
Feb. 19, 2021 (ES) P202130137

(51) Int. Cl. H04R 9/02; H04R 9/06

(52) U.S. Cl. CPC H04R 9/022; H04R 9/06

(57) ABSTRACT

Electrodynamic horn loudspeaker with thermal dissipation whose operation is based on the pressure variations generated in a small air chamber located in front of the membrane, or diaphragm. This type of transducer is made up of a horn and a driver unit, configured to increase thermal dissipation and comprises a winding, an air gap and a magnetic circuit which in turn comprises pole pieces facing the winding and where the increase in thermal dissipation it is obtained by doubling the heat radiating surface in a single layer of winding and increasing the height of the air gap in the same proportion as the coil, its working range being designed to exclusively cover medium and high frequencies.

### FIELD OF THE INVENTION

The present invention relates to the field of electrodynamic loudspeakers and more particularly it relates to electrodynamic horn loudspeakers with improved thermal dissipation (and its manufacturing method) that is configured to increase thermal dissipation in loudspeaker models for medium and high frequencies in general and with an air chamber, by increasing the radiating surfaces of the coil and the air gap.

### BACKGROUND OF THE INVENTION

The electrodynamic horn loudspeaker is formed by a small diaphragm facing an air chamber where very important pressure variations are produced, and actuated by a voice coil. This prevents a significant displacement of the latter from occurring, unlike what happens with direct radiation loudspeakers, especially at medium and high frequencies, which correspond to the working range of this type of loudspeaker.

Some of the electrical power applied to the coil is dissipated as heat due to the Joule effect. This heat is dissipated by natural convection and radiation phenomena, since at these frequencies there is no significant movement of the coil, which could create a displacement of the surrounding fluid, which would give rise to a much more efficient forced convection phenomenon.

On the other hand, this model aims to achieve high performance and a very wide bandwidth. For this, a very light vibrating system is used. This implies that the voice coil has to be relatively small in diameter and very short in height, which results in a very small dissipation area. The usual thing is that this coil has a height less than the thickness of the pole pieces and, to direct the magnetic flux towards it, one of the pieces must be chamfered in the vicinity of the air gap.

One of the most severe limitations in this transducer is that which has to do with the electrical power applied. Indeed, to increase the acoustic pressure it is necessary to apply a greater electrical power. When an electric current travels through the coil, and due to the Joule effect, the coil heats up. This results in a rise of the resistivity of the material that forms the electrical conductor (generally copper or aluminium), which results in an increase in electrical resistance.

This can double the resistive value of the coil and results in a decrease in loudspeaker performance, on the one hand, and a decrease in the power delivered by the amplifier, on the other. This is called power compression losses and is the reason for a very significant drop in the sound pressure level. The other, and more tragic consequence is the destruction of the voice coil due to thermal overload.

To understand how horn driver or any other loudspeaker for medium and high frequency works, it is necessary to refer to its main parts: the coil, the section of the conductor wire and the magnetic circuit.

In low-frequency loudspeakers, there needs to be a significant displacement of the membrane to ensure sufficient sound pressure. This implies that the coil must be able to move in the air gap, keeping the number of turns within it unchanged. Hence an appreciable length of the winding is necessary.

On the contrary, in the models for higher frequencies, the displacement is practically negligible, so it is not necessary for the turns to protrude from the air gap and maximum use is made of the magnetic energy, favoring the coupling factor (B1)2/RE. These voice coils therefore have a much lower height than low-frequency coils and consequently a smaller thermal dissipation surface.

To make the voice coil, materials that are good conductors of electricity are used, such as copper, aluminium or an alloy of both materials. They are presented with a circular section, the most usual, but others with a rectangular section are also described in the state of the art. In the case of a circular section, two layers of wire are usually applied, while, for a rectangular section, when winding it on the edge, it is usual to make a single layer.

Going back to the low-frequency model, the mass of the moving assembly, that is, of all those components that can move, is quite heavy. This is necessary so that the pieces have great rigidity and be able to withstand the mechanical stresses to which they are exposed during these displacements. Therefore, these coils will have a significant size and the magnetic circuit must be adapted to these conditions. For this, the air gap is designed in such a way that all the pole pieces are well dimensioned, making it easier for the coil to move without the risk of rubbing against the aforementioned air gap.

In the other models where this displacement does not occur, as is the case of the medium and high frequency models and, therefore, the forces applied to the diaphragm are much smaller, the aim is to reduce the mass of all the components to maximize the efficiency. In the case of the voice coil, it will be made so that it does not protrude from the air gap, while very high efficiency models—as is the case of horn loudspeakers—the height of the winding is reduced even below the thickness of the pole pieces.

Thus, in the current state of the art, in order to maximize the magnetic flux, an air gap is formed with a height equal to the width of the winding. To do this, the outer pole piece is chamfered, so that the magnetic flux is directed towards the air gap, thus obtaining a very intense induction in the latter.

In short, and with respect to the current state of the art, in low frequency loudspeakers, a long coil has a much larger dissipation area and, therefore, its dissipation capacity, both by natural convection and by radiation, will be greater. On the contrary, that larger size will imply a much higher mass, which will reduce the performance of the loudspeaker or require a more powerful magnetic circuit, which will increase the cost of the driver. In a short coil, with a smaller volume, it can be located within the air gap so that all its turns are covered by the magnetic flux. Its lower weight increases the performance of the speaker. On the contrary, its reduced dissipation area makes it difficult to extract the heat generated in it, limiting the electrical power applied and increasing power compression losses.

The applicant is aware of the existence of other more or less successful solutions, all of them applied to low-frequency loudspeakers, the least efficient being those that apply elements that increase the external area of the loudspeaker, such as heat radiators; such as those disclosed in documents U.S. Pat. Nos. 5,748,760A and 5,533,132A.

These act passively, by natural convection, and only slightly improve the temperature outside the loudspeaker motor, without substantially affecting voice coil cooling. In other cases, non-ferromagnetic elements, heat conductors, are applied in the vicinity of the coil to facilitate the passage of heat from it to the outside (US20030081808A1, U.S. Pat. No. 6,665,414B1), but, as it has already been said, they are only used for low frequency loudspeakers, where the coil protrudes from the air gap permanently, as it is wider than the air gap (see examples in The Journal of Audio Engineering Society, Vol. 40, No1/2 1992 January/February), where the different configurations of the coil and the magnetic circuit. Also U.S. Pat. No. 3,991,286 patent disclose a loudspeaker having a voice coil, spider suspension and speaker frame all made of material having high thermal conductivity, including a horn type speaker embodiment with a thermally conductive horn element and a heat sink member attached on the rear.

In higher frequency models, where it is not possible to introduce additional elements to facilitate the passage of heat from the coil to the outside, a cooling fluid—ferrofluid—can be applied inside the air gap (Entropy 2014, 16, 5891-5900; doi:10.3390/e16115891). This fluid remains within the air gap because it contains, in its composition, iron nanoparticles that “fix” the fluid and prevent it from leaving the air gap. Its efficiency in conducting heat from the coil to the pole pieces is quite good, but it suffers from two drawbacks. The first is the viscosity of the fluid, which “slows down” the coil and modifies its damping, that is, it influences the frequency response of the loudspeaker. The second, that, with the passage of time, the fluid disappears, either by migrating outside the air gap, or by evaporation, so its efficiency decreases, leaving the coil exposed to power values that it can no longer handle.

Regarding the magnetic circuit, if the entire thickness of the pole piece is used to conduct the magnetic flux, the saturation in the areas close to the air gap will be less than in those in which some of the parts that make up it are machined, due to the reduction of the section in this zone.

This will make it difficult for the magnetic flux to pass through, reducing the magnetic induction in the air gap.

That is why none of the solutions described above manages to solve the problem described as the present invention does, neither independently nor by combining them.

### DESCRIPTION OF THE INVENTION

It is a primary object of the present invention to provide a device for thermal dissipation in loudspeakers, and more specifically in electrodynamic moving coil loudspeakers for medium and high frequencies, and more specifically for horn loudspeakers.

As indicated, electrodynamic moving coil loudspeakers are based on the displacement of the coil and, consequently, of the membrane attached to it to produce pressure variations in the ambient air. This is because the electrical energy applied to the coil will generate a force in the latter, due to Laplace's law. However, some of that energy generates heat due to the Joule effect.

To extract this heat from the coil and avoid a thermal overload, which can become irreversible, there are two mechanisms. The first is by convection [Eq.1] and will be of the natural type, as the coil is only in contact with a gaseous fluid. If, in addition, a displacement occurs, a movement of the surrounding air is generated, which gives rise to forced convection. But this effect only occurs in low-frequency cone models, which are not the object of the present invention.

Q_{Convection}=hA(Tₛ−Tₐ) [Ec. 1]

Additionally, there is a phenomenon of dissipation by radiation, which is described in [Eq.2]:

Q_{Radiation}=σεA(Tₛ⁴Tₐ⁴) [Ec.2]

As can be seen, in both cases there is a proportionality between the heat extracted and the area A of the voice coil. This area is defined as its perimeter multiplied by its height. That is, for coils of the same diameter, the area will be proportional to the height of the winding.

Currently, in horn loudspeakers, to improve the applied power and achieve higher acoustic pressure, it is necessary to increase the size of the voice coil. This, as mentioned above, increases the dissipation area. The way to carry it out is by increasing the diameter, but keeping the height of the winding practically unchanged. In any case, it is necessary to magnify the size of the magnetic circuit, which implies a greater volume and mass and increases the cost of the loudspeaker.

An object of the present invention is to provide a solution to the problems described in the current state of the art without having an impact on cost or technical performance. In other words, it is a solution that can be implemented both in new developments and in existing models. This represents a fundamental advantage over other loudspeakers, since right now this type of loudspeaker has limited performance due to the increase in power compression losses as the applied electrical power increases.

It is a fundamental object of the invention that the thermal dissipation device of the invention does not affect the performance of the loudspeaker, which, as indicated in [Eq.3], depends mainly on the force factor, BI, which represents the product of the induction B by the length I of the wire from the coil, nor on the response at high frequency, which depends, among others, on the mass of the coil.

$${E}_{ff} max = \frac{100 {( Bl )}^{2}}{( \sqrt{{( Bl )}^{2} + {S}_{D} {ρ}_{0} {cR}_{E}} ) + {( \sqrt{{S}_{D} {ρ}_{0} {cR}_{E}} )}^{2}} \qquad [ Ec \text{.3} ]$$

As previously mentioned, the voice coil can be made with circular section wire or rectangular section wire. In the first case two layers are applied to the winding, while in the second only one is applied. In this case, it has already been mentioned that the width of the winding, for the horn loudspeakers, is less than the thickness of the external pole piece and that, in order to maximize the magnetic flux that affects the coil, it is chamfered to reduce thickness until the same width as the height of the winding is achieved.

This solution, by reducing the section of the pole piece, causes a strong magnetic saturation in the areas adjacent to the air gap, with an increase in the reluctance of the circuit and, therefore, forces part of the magnetic flux to seek a different path instead of passing through the air gap, causing the energy in it to be less than expected. Even so, there is no doubt that, if this narrowing is not carried out, part of the flux would not pass through the coil, which is a way of avoiding greater losses.

However, these areas that are closest to the coil will also be affected by the heat emitted by the latter, and which, by conduction, will extract it out of the magnetic structure into the ambient air. If the temperature gradient between the coil and the areas adjacent to the air gap, in the pole pieces, is not very high, according to equations (1) and (2), the heat transfer between one and the other will be hindered. In addition, as has already been said, the dissipation area of the coil will be equal to the product of its perimeter by the width of the winding. By presenting a relatively small area, dissipation will be difficult and there will be a rapid rise in temperature and a strong increase in compression losses.

The solution provided by the present invention consists of doubling the dissipation area of the coil in order to double the admissible power, or else, with the same working conditions, reduce the temperature of the coil with the consequent decrease in power compression losses. As already discussed in this specification, the doubling of the coil dissipation area has to be done without increasing the mass of the coil or changing the electrical resistance. Well, to carry it out, the coil is made with the same diameter of wire and with the same number of turns as the original, but instead of winding with two layers, a single layer is applied.

Now, the air gap must be adapted to the new height of the coil, this is done by reducing the chamfering of the upper pole piece and bringing this piece closer in the same proportion as the thickness of the layer that has been removed, since the outer diameter of the coil has decreased. In this way there will be an air gap with less separation, which reduces the leakage of magnetic flux to the outside and avoids such a high saturation in the areas close to it, allowing a greater magnetic flux to pass through it. Likewise, as there is a larger area in the pole pieces facing the coil, the heat absorption capacity will be improved, and it will facilitate the conduction of heat through these to the outside of the magnetic circuit.

In a second embodiment of the invention, a rectangular section wire is used, whose main advantage is that, as there are no gaps between the turns, as occurs in the embodiment with a circular section wire, the stacking factor is greater and, therefore, more turns can be included in the same space. This is possible because the winding is done by winding the turns on the edge. In this second embodiment, since the voice coil is single-layer, it will be necessary to modify the dimensions of the section of the flat wire, while keeping it unchanged. In addition, the same number of turns will be maintained so as not to modify the length or the electrical resistance, until the new winding width is twice as wide as the original model.

Throughout the description and claims the word “comprise” and its variants are not intended to exclude other technical characteristics, additives, components or steps. Other objects, advantages and features of the invention will be apparent to those skilled in the art in part from the description and in part from the practice of the invention. The following examples and drawings are provided by way of illustration, and are not intended to limit the present invention.

Furthermore, the present invention covers all possible combinations of particular and preferred embodiments indicated herein.

### BRIEF DESCRIPTION OF THE DRAWINGS

Next, a series of drawings that help to better understand the invention and that are expressly related to an embodiment of said invention that is presented as a non-limiting example of it are described very briefly.

FIG. 1 shows a view of a horn loudspeaker assembly, of the type known in the current state of the art.

FIG. 2 shows a partially sectioned view of the horn loudspeaker, with the different parts.

FIG. 3 shows a detailed view of the solution for a two-layer coil with circular section wire and short air gap.

FIG. 4 shows a sectional view of the solution with a single-layer coil twice as wide as the two-layer coil, wire with a circular section and a higher air gap.

FIG. 5 shows a schematic view of heat capture and dissipation in the first practical embodiment of the invention.

FIG. 6 shows a detailed view of the solution for a single layer voice coil with rectangular section wire. Where, FIG. 6A shows the solution of the current state of the art, while FIG. 6B shows the solution of the invention according to the second practical embodiment of the invention.

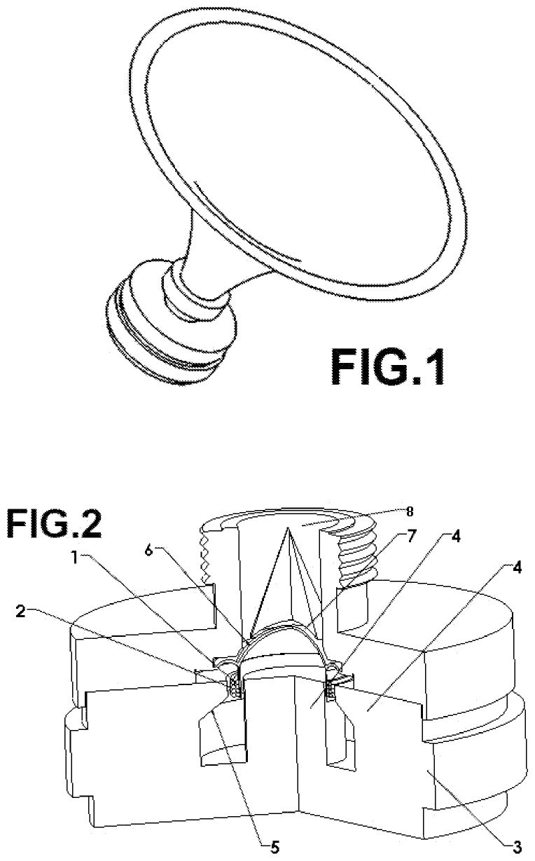

### EXPLANATION OF A DETAILED EMBODIMENT OF THE INVENTION

As can be seen, the main parts of the invention are described with reference to the attached figures. Thus, the horn loudspeaker with thermal dissipation will essentially be made up with a voice coil (1), an air gap (2) and a magnetic circuit (3). The protruding elements of the magnetic circuit (3), facing the winding (1) and that conduct the magnetic flux provided by the magnet are called pole pieces (4). A diaphragm (6), the air chamber (7) and the exit (8) to the horn.

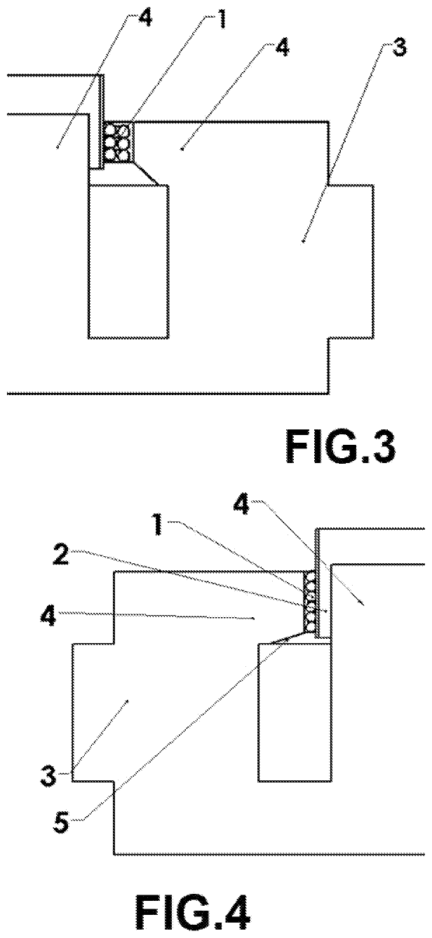

In the first embodiment, the dissipation area of the coil (1) is doubled, to double the nominal power, or else, with the same working conditions, reduce the temperature in the coil (1) with the consequent decrease in power compression losses. To do this, the coil (1) is made with the same wire diameter and with the same number of turns as the original, but instead of two layers as in the current state of the art (FIG. 3), with a single layer. (FIG. 4).

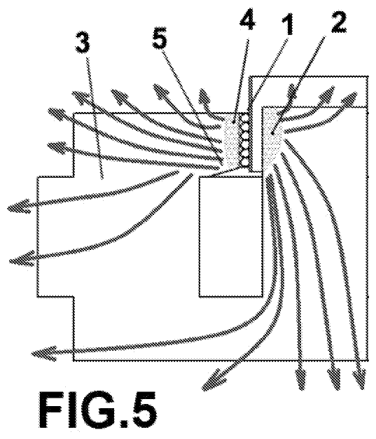

In this embodiment, the air gap (2) has to be adapted to the new height of the coil (1). This is done by reducing the chamfering (5) of the pole piece (4) and bringing said pole piece (4) closer together in the same proportion as the thickness of the wire layer that has been removed, since the outer diameter of the coil has decreased. In this first practical embodiment, the air gap (2) has a smaller separation than in the double layer embodiment, reducing the leakage of magnetic flux from the outside and also avoiding high saturation in the areas close to the air gap (2), favoring a higher magnetic induction in the latter. Likewise, since there is a larger area in the pole pieces (4) facing the coil (1), the heat absorption capacity is improved, and it facilitates the conduction of heat through the first ones towards the outside of the magnetic circuit, as and as can be seen with the arrows in FIG. 5.

Thus, with the first practical embodiment of the invention, the following advantages are obtained:

| State of the art | First embodiment |
|---|---|
| Two layer coil | Single layer coil |
| Coil with narrow winding width | Coil with double winding width |
| Short air gap | Air gap with double height |
| Wider air gap | Narrower air gap |
| High magnetic saturation in pole pieces | Less magnetic saturation in pole pieces |
| Heat concentration in areas adjacent to | Lower concentration of heat in areas |
| the air gap | adjacent to the air gap |
| Low thermal dissipation capacity | High thermal dissipation capacity |
| High power compression losses | Low power compression losses |
| Risk of thermal overload and destruction | Reduced thermal overload and lower risk |
| of the voice coil | of voice coil destruction |

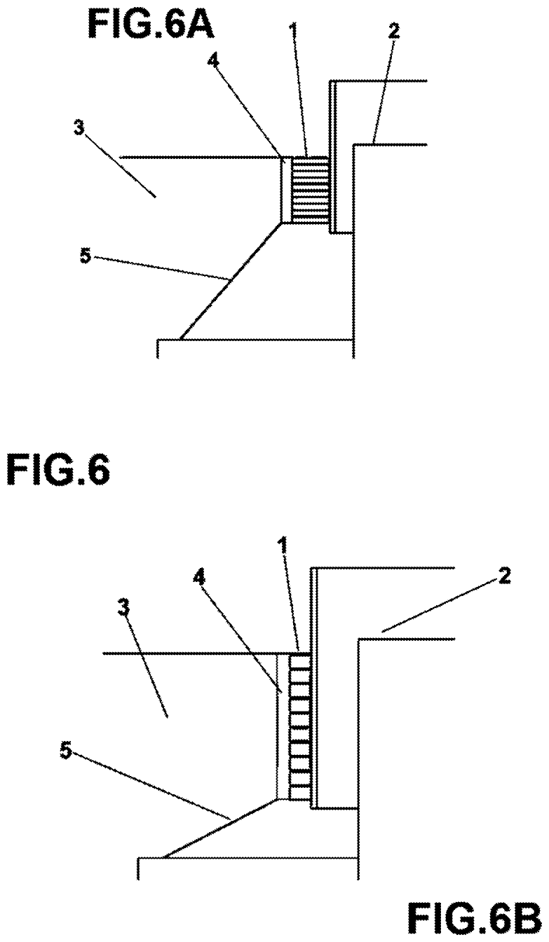

In a second practical embodiment of the invention, it will be necessary to modify the measurements of the flat wire of the coil (1), while always maintaining the same section. In addition, the same number of turns is maintained so as not to modify the length and the electrical resistance, until the new winding width is twice that of the original model. Thus, in the example of FIG. 6A, it is observed as a coil (1) that had, for example, 3 mm winding width, formed by 20 turns of flat wire, with dimensions 0.15×0.45 mm, that is to say a section of 0.0675 mm2 (FIG. 6A). A winding width of 6 mm would be made, then the wire measurements would be 0.3×0.225 mm (FIG. 6B).

This would allow the 20 turns to be maintained and the resistance and mass of the wire would remain unchanged. The air gap (2) would be reduced by the difference between 0.45 and 0.225, that is, by 0.225 mm, and its height would have to be resized to adapt it to the new size of the coil (1).

Thus, with the second practical embodiment of the invention, the following advantages are obtained:

| State of the art | Second embodiment |
|---|---|
| Single layer coil flat wire | Single layer coil with modified flat wire |
| Coil with narrow winding width | Coil with double winding width |
| Short air gap | Air gap with double height |
| Air gap with more separation | Narrower air gap |
| High magnetic saturation in pole pieces | Less magnetic saturation in pole pieces |
| Heat concentration in areas adjacent to | Lower concentration of heat in areas |
| the air gap | adjacent to the air gap |
| Low thermal dissipation capacity | High heat dissipation capacity |
| High power compression losses | Lower power compression losses |
| Risk of thermal overload and destruction | Reduced thermal overload and lower risk |
| of the coil | of coil destruction |

The manufacturing method of a horn loudspeaker that will be configured to increase the thermal dissipation comprises a voice coil (1), an air gap (2) and a magnetic circuit (3) that it comprises, in turn, pole pieces (4) facing the coil (1) and characterized in that it comprises doubling the heat radiating surface of the winding (1) in a single layer.

And in turn, it will include doubling the height of the winding (1) with a circular section in the air gap (2), and doubling the width of the winding (1) with a rectangular section in the air gap (2).

1. An electrodynamic horn loudspeaker with thermal dissipation that, being configured to increase thermal dissipation in loudspeaker models for medium and high frequencies, comprises a voice coil (1), an air gap (2) and a magnetic circuit (3) that comprises at its pole pieces (4) facing a winding (1) and that an increase in thermal dissipation is obtained by doubling a heat radiating surface in a single layer of winding (1); and
characterized in that
where a wire that makes up the winding of the voice coil (1) has a circular section, two layers, and the increase in the radiating surface is obtained by doubling a height of the winding (1), passing to a single layer winding in the air gap (2), which is elongated in the same proportion as the coil.

2. (canceled)

3. The loudspeaker according to claim 1, where the wire that makes up the winding of the voice coil (1) has a rectangular section, single layer and the doubling of the radiating surface is obtained by doubling a width of the winding (1) in the air gap (2), which lengthens in the same proportion as the coil.

4. A method of manufacturing a horn loudspeaker according to claim 1, which, being configured to increase thermal dissipation in loudspeaker models for medium and high frequencies, comprises a coil (1), an air gap (2) and a magnetic circuit (3) comprising, in turn, pole pieces (4) facing a winding (1), wherein the method comprises doubling the heat radiating surface of the winding (1) in a single layer.

5. The method of manufacturing according to claim 4 comprising doubling the height of the winding (1) of the circular section in the air gap (2).

6. The method of manufacturing according to claim 4 comprising doubling a width of the winding (1) of a rectangular section in the air gap (2).

7. A method of manufacturing a horn loudspeaker according to claim 3, which, being configured to increase thermal dissipation in loudspeaker models for medium and high frequencies, comprises a coil (1), an air gap (2) and a magnetic circuit (3) comprising, in turn, pole pieces (4) facing a winding (1), wherein the method comprises doubling the heat radiating surface of the winding (1) in a single layer.

8. The method of manufacturing according to claim 7 comprising doubling the height of the winding (1) of circular section in the air gap (2).

9. The method of manufacturing according to claim 7 comprising doubling the width of the winding (1) of the rectangular section in the air gap (2).
